(19) United States
(12) Patent Application Publication
(10) Pub. No.: US 2011/0089673 A1
(43) Pub. Date: Apr. 21, 2011

(54) VEHICLE PASSENGER COMPARTMENT CLADDING ELEMENT FOR A COLUMN OF A MOTOR VEHICLE

(75) Inventor: Carsten GLASER, Muhltal (DE)

(73) Assignee: GM GLOBAL TECHNOLOGY OPERATIONS, INC., Detroit, MI (US)

(21) Appl. No.: 12/904,865

(22) Filed: Oct. 14, 2010

(30) Foreign Application Priority Data
Oct. 14, 2009 (DE) 102009049365.4

(51) Int. Cl. B60R 21/16; B62D 25/04

(52) U.S. Cl. 280/730.2; 296/193.06

(57) ABSTRACT

A vehicle passenger compartment cladding element is provided for a column of a motor vehicle with a head airbag module arranged in the area of the column, which has a base body with an open profile cross section, and a front cover, which accommodates an attachment bracket for securing to a vehicle structure and at least one support element, which to be supported against the vehicle structure is arranged to the side of the attachment bracket toward the edge of the base body on the front cover.

### CROSS-REFERENCE TO RELATED APPLICATION

This application claims priority to German Patent Application No. 102009049365.4, filed Oct. 14, 2009, which is incorporated herein by reference in its entirety.

### TECHNICAL FIELD

The technical field relates to a vehicle passenger compartment cladding element for a column of a motor vehicle, as well as to a motor vehicle with such a vehicle passenger compartment cladding element

### BACKGROUND

Known from DE 103 44 778 B4, for example, is a B-column cladding for a motor vehicle, which has a head airbag module arranged in the roof area. The airbag is deployed by igniting a gas generator, folding open an airbag cover that previously had covered it toward the vehicle passenger compartment.

As a rule, these column cladding have a base body with an open profile cross section, for example U-shaped, the open profile side of which faces away from the vehicle passenger compartment and toward the vehicle body. Such open profiles can be readily manufactured, are lightweight, and advantageously permit the covered accommodation of mechanical, electrical and other systems between the vehicle structure and a surface of the column cladding facing the vehicle passenger compartment.

However, one disadvantage is that open profiles have less torsional rigidity. During a collision involving the front corner of the profile, for example, this can cause an outside, free edge of the profile, such as a short leg of a U-profile, to become twisted into the vehicle passenger compartment. This gives rise to the danger of a vehicle passenger suffering an injury, or the deploying airbag getting snagged on the corner, thereby disrupting its deployment.

Known from U.S. Pat. No. 7,172,211 B2 is a B-column cladding that has two attachment brackets spaced apart from each other. The latter engage corresponding recesses in the vehicle structure from the back, and could support a torsional moment on the front side owing to their spacing. However, the column cladding is designed throughout as an open hollow profile without a front cover, so that the low torsional rigidity also gives rise to the aforementioned danger of one corner of the torsionally soft profile being twisted into the vehicle passenger compartment.

Known from EP 1 997 692 A2 is a B-column cladding according to the introductory clause of claim 1, with a base body having an open profile cross section and a closed front cover, the center of which accommodates an attachment bracket. The latter engages a corresponding recess in the vehicle structure from the back. The torsional rigidity is here higher due to the front cover. However, the single, central attachment bracket does not make it possible to support torsional moments, so that the danger explained above of one corner of the profile being twisted into the vehicle passenger compartment comes into play once again.

Therefore, at least one object is to improve the known arrangement. In addition, other objects, desirable features, and characteristics will become apparent from the subsequent summary and detailed description, and the appended claims, taken in conjunction with the accompanying drawings and this background.

### SUMMARY

In general, a motor vehicle according to an embodiment of the invention has a vehicle structure with at least one column, in particular a central or B-column. In particular, the vehicle structure can encompass a body of the motor vehicle. A head airbag module is arranged in this area of the column. The latter can extend as a so-called curtain or roof rail airbag along an interior roof edge between the A- and C-column over the B-column, or between the respective A- or C- and B-column.

A ramp element preferably made of metal for higher stability can be integrated into the body, or joined thereto as a separate, detachable (e.g., screwed) or permanent (e.g., welded) part, so as to guide the airbag as it deploys. In particular, such a ramp element can have a retaining section for attachment to the body and/or mounting the head airbag module and a sheet or plate guide section folded to the latter.

One vehicle passenger compartment cladding element according to an embodiment of the invention for this column has a base body with an open profile section and front cover. In particular, the open profile cross section refers to a cross section essentially perpendicular to the longitudinal direction of the vehicle passenger compartment cladding element, which is U- or L-shaped, wherein the open profile side faces away from the vehicle passenger compartment and toward the vehicle structure when assembled.

In a preferred embodiment, the front cover has essentially a closed design. A completely or sectionally closed cover is here understood in particular as a cover having no recesses open toward the open profile side at all, or in this section. By contrast, closed recesses, in particular pocket or through boreholes or the like whose periphery is entirely bordered by material, can also be present in a sectionally closed cover as described, since they do not detract excessively from torsional rigidity.

An attachment bracket for attachment to the vehicle structure is arranged on the front cover, preferably in an essentially central location. The term central here preferably refers to the longitudinal direction of the vehicle or a longer primary axis of the open profile cross section of the base body. This attachment bracket can be positively and/or non-positively secured to the vehicle structure. In particular, it can engage the ramp element of the vehicle structure form the back, at least partially in a positive manner. To this end, it has a ramp-shaped support surface to provide support on the side of the ramp element facing away from the airbag in a preferred embodiment. Such a support surface directly guide the airbag as it deploys, even in conjunction with a ramp element of the vehicle structure or in its place.

The front cover imparts an elevated torsional rigidity to the vehicle passenger compartment cladding element. In order to support the base body made more torsionally rigid in this way at least on the front side against the vehicle structure to prevent one corner from twisting out into the vehicle passenger compartment, one or more support elements are now provided, which to be supported against the vehicle structure are arranged to the side of the attachment bracket toward the edge of the base body on the front cover.

This results in a vehicle passenger compartment cladding element with a torsionally rigid design and support, which reduces the danger of a passenger suffering an injury or the deploying airbag getting snagged on a corner, for example one that becomes turned into the vehicle passenger compartment as the vehicle structure is twisted during an unfavorable collision.

In particular, if the attachment bracket is situated essentially in the center on the front cover, and hence acts as a quasi pivot bearing around the longitudinal axis of the vehicle passenger compartment cladding element, one or more support elements, preferably then arranged on either side of the attachment bracket, can support a torsional moment, and reduce or prevent the twisting of a free profile corner. To this end, it is advantageous for the support element(s) to be arranged in proximity to the free corner(s).

A support element should first and foremost have enough rigidity in a support direction toward the vehicle passenger compartment, while on the other hand not unnecessarily increase the weight of the vehicle passenger compartment cladding element. For this reason, a support element is provided with one or more ribs in a preferred embodiment, which are preferably aligned essentially in the transverse direction of the vehicle. The ribs can here also be interconnected by a plate to improve rigidity and load distribution.

In a preferred embodiment, one or more support elements also have a ramp-shaped support surface. Just as the attachment bracket, this allows them to engage a ramp element of the vehicle structure from the back at least partially in a positive manner, and/or directly guide the airbag during its deployment in conjunction with a ramp element of the vehicle structure or in its place.

Designing the front cover as a single piece with the base body, attachment bracket and/or support element(s) can simplify the manufacture or assembly process or reduce the weight, as can making it out of plastic.

In a preferred embodiment, an airbag cover, in particular the interior roof lining of the vehicle, is detachably or permanently held on the vehicle structure and/or vehicle passenger compartment cladding element. In particular in this case, the head airbag must have no separate cover, but can be secured in the vehicle as a so-called soft-bag.

### BRIEF DESCRIPTION OF THE DRAWINGS

The present invention will hereinafter be described in conjunction with the following drawing figures, wherein like numerals denote like elements, and:

FIG. 1 is a part of a motor vehicle according to an embodiment of the present invention in a section along a vehicle transverse axis denoted on FIG. 3 by the intersecting line I-I;

FIG. 2 is a vehicle passenger compartment cladding element of the motor vehicle according to FIG. 1, front view;

FIG. 3 is the vehicle passenger compartment cladding element of the motor vehicle according to FIG. 2, top view; and

FIG. 4 is a vehicle passenger compartment cladding element according to prior art in the view shown on FIG. 3.

### DETAILED DESCRIPTION

The following detailed description is merely exemplary in nature and is not intended to limit application and uses. Furthermore, there is no intention to be bound by any theory presented in the preceding background or summary or the following detailed description.

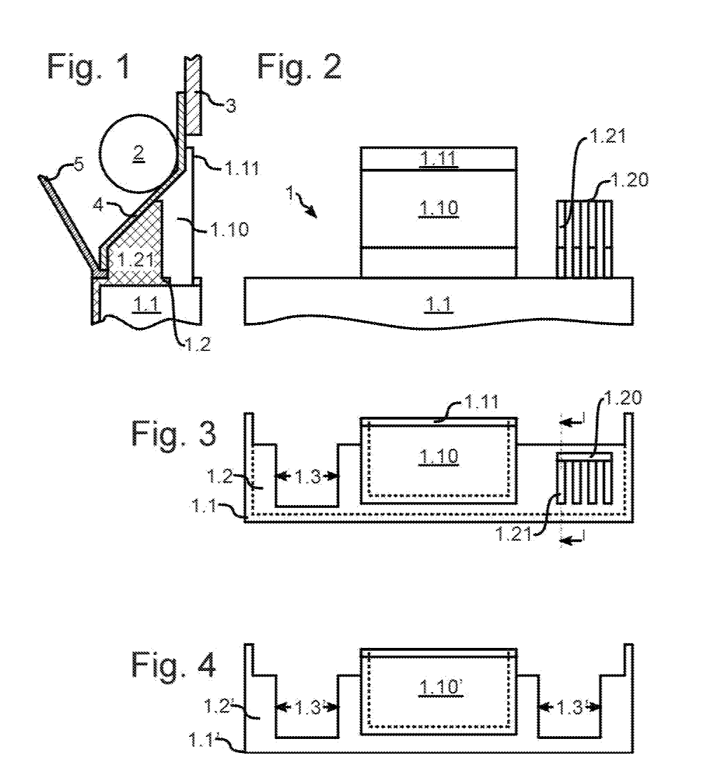

In a section along a vehicle transverse axis as denoted by the intersecting line I-I on FIG. 3, FIG. 1 shows part of a vehicle structure 3, in particular a roof rail. A sheet metal ramp 4 is secured to the latter in a manner not shown in any greater detail, and in turn has secured to it via attachment brackets a head airbag module 2 in the form of a soft-bag with rolled-in bag material, also in a manner not shown in any greater detail. Toward the vehicle passenger compartment (left of FIG. 1), the latter is covered by an airbag cover in the form of a vehicle roof lining 5, which is detachably mounted in a gap between the folded guide section of the sheet metal ramp 4 and a front cover 1.2 of an ensuing B-column cladding 1 according to an embodiment of the invention described in greater detail below, so that it can be folded away and into the passenger compartment when the airbag deploys. During deployment, the airbag is guided through the ramp-shaped guide section of the sheet metal ramp 4, which is folded relative to a retaining section of the sheet metal ramp 4 with which the latter is secured to the vehicle structure 3.

The structural design of the B-column cladding 1 can be gleaned from an overall view of FIGS. 1 to 3. It encompasses a base body 1.1, the U-shaped open profile cross section of which is denoted by the dashed line in the top view on FIG. 3, and discernable in the section of FIG. 1. A cover 1.2 is molded integrally with the base body 1.1 out of plastic on the front side toward the airbag 2. As evident in particular on FIG. 3, the latter has essentially a closed design in the area of a support element 1.20 described in greater detail below. In this case, the above implies that there are no open recesses 1.3 around the edges. For purposes of comparison, FIG. 4 depicts a front cover 1.2′ having recesses 1.3′ open to the side on either side of an attachment bracket 1.10′. This unsealed cover 1.2′ imparts virtually no additional torsional stability to the base body 1.1 with the open U-profile, thereby creating the danger that one of the free corners (top left or right on FIG. 4) will twist into the vehicle passenger compartment during a collision of the vehicle. In a modification not shown, a cover 1.2 according to an embodiment of the invention can also have a closed design on either side of a central attachment bracket 1.10, in particular be symmetrical, i.e., with support elements on either side.

On FIG. 2, an attachment bracket 1.10 is integrally and centrally designed with the cover 1.2 on the front cover 1.2. As also denoted on FIG. 3, the latter also has a U-profile with a ramp-shaped area followed by an area 1.11 (see FIG. 2) in the longitudinal direction of the base body 1.1 (from the bottom up on FIG. 1, 2). As evident from FIG. 1, the attachment bracket 1.10 uses the latter and the ramp-shaped area to engage the sheet metal ramp 4 from the back, thereby working together with other attachment devices (not shown), such as clips, screws or the like, to secure the B-column cladding 1 to the vehicle structure 3.

A support element 1.20 is integrally designed with the cover in the closed area of the cover 1.2 that tends to twist into the vehicle passenger compartment during a lateral/frontal collision of the vehicle, and thereby impedes the deployment of the airbag 2, specifically the right corner on FIG. 2, 3. It encompasses several interconnected ramps 1.21 in a rear wall in the supporting direction (from the bottom up on FIG. 3), with ramp-shaped sections that are supported against the sheet metal ramp 4 on the rear side, just as the central attachment bracket 1.10.

This additional support element 1.20 in proximity to the edge and the front cover 1.2 that is closed in this area together provide a B-column cladding that is supported in a torsionally rigid manner, which reduces or prevents a twisting of the supported free end into the vehicle passenger compartment.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A vehicle passenger compartment cladding element for a column of a motor vehicle with a head airbag module arranged in an area of the column, comprising:
a base body with an open profile cross section;
a front cover that accommodates an attachment bracket adapted to secure to a vehicle structure; and
a support element adapted for support against the vehicle structure and arranged to a side of the attachment bracket toward an edge of the base body on the front cover.

2. The vehicle passenger compartment cladding element according to claim 1, wherein the column is a central of B-column.

3. The vehicle passenger compartment cladding element according to claim 1, wherein the front cover is essentially sealed at least in the area of the support element.

4. The vehicle passenger compartment cladding element according to claim 1, wherein the support element is arranged on either side of the attachment bracket

5. The vehicle passenger compartment cladding element according to claim 1, wherein the support element comprises at least one rib.

6. The vehicle passenger compartment cladding element according to claim 1, wherein the attachment bracket comprises a ramp-shaped support surface.

7. The vehicle passenger compartment cladding element according to claim 1, wherein the support element comprises a ramp-shaped support surface.

8. The vehicle passenger compartment cladding element according to claim 1, wherein the front cover is a single piece with at least one of the base body, the attachment bracket or the support element.

9. The vehicle passenger compartment cladding element according to claim 1, wherein the open profile cross section is essentially U-shaped.

10. The vehicle passenger compartment cladding element according to claim 1, wherein the open profile cross section is essentially V-shaped.

11. The vehicle passenger compartment cladding element according to claim 1, wherein the open profile cross section is essentially T-shaped.

12. The vehicle passenger compartment cladding element according to claim 1, wherein the open profile cross section is essentially H-shaped.

13. The vehicle passenger compartment cladding element according to claim 1, wherein the open profile cross section is essentially L-shaped.

14. The vehicle passenger compartment cladding element according to claim 1, wherein the attachment bracket is essentially centrally located on the front cover.

15. A motor vehicle structure, comprising:
a column;
a head airbag module arranged in an area of the column; and
a vehicle passenger compartment cladding element secured to the column, the vehicle passenger compartment cladding element comprising:
a base body with an open profile cross section;
a front cover that accommodates an attachment bracket adapted to secure to a vehicle structure; and
a support element adapted for support against the vehicle structure and arranged to a side of the attachment bracket toward an edge of the base body on the front cover.

16. The motor vehicle structure according to claim 15, further comprising a ramp element adapted to guide deployment of an airbag.

17. The motor vehicle structure according to claim 15, wherein at least one of the attachment bracket or the support element is secured to the vehicle structure.

18. The motor vehicle structure according to claim 16, wherein at least one of the attachment bracket or the support element at least partially engages the ramp element of the vehicle structure from a back.

19. The motor vehicle structure according to claim 15, further comprising an airbag cover detachably held on the vehicle passenger compartment cladding element.
